(19) United States
(12) Patent Application Publication
(10) Pub. No.: US 2011/0082731 A1
(43) Pub. Date: Apr. 7, 2011

(54) Targeted, Deferred Redemption Coupon System

(75) Inventor: Jonathan Kepecs, Woodside, CA (US)

(73) Assignee: CONCEPT SHOPPING, INC., Lisle, IL (US)

(21) Appl. No.: 12/575,208

(22) Filed: Oct. 7, 2009

(51) Int. Cl. G06Q 30/00; G06Q 10/00; G06K 19/00

(52) U.S. Cl. 705/14.17; 705/14.22; 705/14.26; 705/14.34; 705/14.36; 705/14.38; 235/487

(57) ABSTRACT

A system for avoiding fraud in the distribution and redemption of coupons is presented. A coupon is targeted to a particular customer and has a customer identifier which maps the coupon to the customer in some way. The coupon provides for two redemptions, an initial redemption for a nominal amount, including zero, and a deferred redemption which provides an incentive for redeeming the coupon. Upon purchasing an item or engaging in an activity urged by the coupon, the coupon is initially redeemed. After the redeemed coupon is validated and cleared, the customer identified through the customer identifier, is rewarded by the deferred redemption amount. Fraud is not rewarded since the initial redemption amount provides for little or no compensation.

### BACKGROUND OF THE INVENTION

This invention is related to customer product marketing technology and, more specifically, to a system and method of distributing and redeeming paper coupons which discourages fraud.

The coupon business amounts to billions of dollars annually and a major problem with coupons is fraud. According to the Coupon Information Corporation, an association of consumer product manufacturers, companies and consumers are losing an estimated 500 million dollars annually due to coupon fraud. A particularly fertile area of coupon fraud is the ordinary paper coupon. Recently a pet food manufacturer issued 250 coupons for a free bag of dog food and within five months more than 2,500 coupons were redeemed—more than 9 out of 10 coupon redemptions were fraudulent. In another case a well-known soft drink manufacturer was forced to discontinue its national marketing campaign due to widespread coupon fraud.

Each paper coupon contains a bar code that indicates the type of product to which the coupon is to be applied and the value of the redemption, and optionally other details, such as the expiration date, limitations on the coupon use and the like. These coupons are generally distributed in mass print media, such as in the advertising sections of newspapers. Unfortunately paper coupons are easy to copy and to forge. Photocopiers are available everywhere for the unwanted copying of the coupons and it is also not difficult to print a coupon bar code on a piece of paper to create what appears to be a valid coupon or which could be used at a self-checkout terminal, commonly found in supermarkets today, to evade a human inspection of the coupon for fraud. While coupon clearing houses have sophisticated methods to discern valid from fraudulent coupons, such methods are too expensive and time-consuming to be adaptable at the point-of-sale terminals where the paper coupons are redeemed.

Newer versions of the traditional paper coupon rely upon computers and the Internet to distribute the coupons electronically. The coupons are printed at home. Partly because print-at-home coupons are printed on regular home printer paper, fraud is difficult to detect and there has been some resistance to such coupon distribution methods. Some print-at-home coupon providers include an additional unique serial number which is tied to an anonymous user account or a user account that is tied to user-supplied credentials, such as an e-mail address that can be easily forged or supplied as a temporary e-mail address from an anonymous user. Such temporary e-mail addresses are easily obtainable. When the coupons are cleared (generally too late to prevent the retailer from accepting the coupon), the serial numbers on the coupon are checked for fraudulent duplicates. Other forms of fraud can be detected, but dealing with fraud after it has occurred is difficult. Other heuristics can be employed to tie promotions to a given computer, such as by examining the state left on that computer (e.g., files or registry modifications), the IP address associated with the user's Internet connection and the like, but these are easily circumvented by determined wrongdoers and, at any rate, do nothing to prevent the counterfeiting of coupons.

Another fraud prevention feature is the installation of special printer driver software in the customer's machine through which the coupon must be printed. This feature makes it more difficult for a user to download the image of a coupon for editing. This can be circumvented by sophisticated by sophisticated wrongdoers who write software which emulates existing printer drivers, or simply scan in the printed paper coupon, or otherwise emulate the image printed on the coupon. The coupons printed by a legitimate printer driver may have subtleties inserted in the printing process which may be difficult to copy, but requiring retail store employees to detect counterfeit coupons from tiny printing differences is an unrealistic burden. Despite the most robust of the print-at-home coupon solutions, it is still easy to forge a coupon. The printed coupon can be photocopied and a duplicate readily presented to the retailer. It can be scanned in a computer and then edited to render all of the security precautions of the special printer driver irrelevant. Furthermore, by simply using other computers to print coupons, a customer can obtain as many copies of a coupon as they wish legally, without trying to disable the copy-protection software. While forging a valid serial number for the coupon may be difficult, it is still virtually impossible to prevent fraud at the retailer level since retailers cannot manually check coupon serial numbers in real time at the checkout lanes—slowing down a checkout lane is strictly forbidden in large retail environments, such as supermarkets. Thus, fraudulent coupons that look like legitimate print-at-home coupons can still be redeemed and by the time the fraud is detected, the retailer has already reimbursed the customer who has left the premises. While the coupon issuer may refuse to honor the fraudulent coupon's value to the retailer, the retailer has already have paid the customer and thus suffers a loss. Furthermore, any paper coupon can be scanned at a self-checkout lane and the appearance of the coupon or its serial number if supplied does not even matter—only the coupon bar code does. The coupon need not be even tendered at self-checkout lanes, which result in a discount to the consumer and a loss to the retailer which is unable to present a physical coupon to the manufacturer to be compensated for the discount to the consumer. The checkout terminal itself ignores additional codes such as the serial number. A print-at-home coupon with a forged serial number is not even traceable back to the IP address or other information provided at the time of the customer's enrollment in the print-at-home coupon program.

Even coupon clearinghouses have been found to engage in fraud. One way is to obtain many legitimate coupons (e.g., those collected from thousands of newspapers) and submit these supposedly redeemed and validated coupons on behalf of colluding stores. Even valid print-at-home coupons can be obtained in large quantities by using some of the previously described techniques.

Therefore, it is highly desirable that a way be provided of preventing or substantially reducing the amount of fraudulent coupons. The present invention provides for such a solution.

### BRIEF SUMMARY OF THE INVENTION

The present invention also provides for a coupon to avoid fraud in the redemption of coupons by customers. The coupon comprises a paper substrate; a customer identifier on the substrate, the identifier associated with a particular customer; a description of one or more items on the substrate; a first redemption amount on the substrate for redemption upon purchase of the one or more items indicated by the coupon and tender of the coupon at a point-of-sale (POS) system; and a second redemption amount on the substrate for deferred redemption upon cleared validation of the coupon. The first redemption amount is much less than the second redemption amount, or zero.

The present invention provides for a method of avoiding fraud in the redemption of coupons. The method comprises the steps of: receiving a coupon associated with the sale of one or more items to a customer, the coupon having been redeemed for a first redemption amount by the customer; associating a customer identifier on the coupon with the customer through a lookup table; and providing for a second redemption amount to the customer after validation of the coupon; whereby the possibility of fraud is reduced. The first redemption amount is much less than the second redemption amount, or even zero.

The present invention provides for a computer system administering the distribution and redemption of coupons. The computer system including elements comprising at least one processor; at least one memory unit; computer code stored in the memory unit; and a network interface; wherein the elements are configured to receive a coupon associated with the sale of one or more items to a customer, the coupon having been redeemed for a first redemption amount by the customer; associate a customer identifier on the coupon with the customer through a lookup table, and provide for a second redemption amount of the coupon amount to the customer after validation of the coupon; whereby the possibility of fraud is reduced. The first redemption amount is much less than the second redemption amount, or even zero.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates graphically the general operation of a conventional paper coupon system.

FIG. 2 illustrates graphically the general operations of a coupon distribution and redemption system, according to one embodiment of the present invention.

FIG. 3A shows a face of an example coupon, according to one embodiment of the present invention; FIG. 3B shows the face of another example coupon with a zero initial redemption amount, according to another embodiment of the present invention.

FIG. 4 illustrates graphically the operations of a particular paper coupon distribution and redemption system, according to another embodiment of the present invention.

FIG. 5A is a computer network illustrating the possible electronic connections between the entities of FIG. 2; FIG. 5B is a computer network illustrating the possible electronic connections between the entities of FIG. 4; FIG. 5C is a block diagram of a computer system of one of the entities of the FIGS. 5A and 5B networks.

FIG. 6A is a flow chart of general operations of the coupon administrator; FIG. 6B illustrates examples of the provide coupon to customer step in FIG. 6A; FIG. 6B illustrates the examples of the provide deferred redemption amount to customer step in FIG. 6A.

To foster a better understanding of the present invention, it should be noted that the same reference numerals are used where the elements, steps, operations and the like are identical or nearly identical in different drawings.

### DETAILED DESCRIPTION OF THE INVENTION

Operations of a Conventional Coupon System

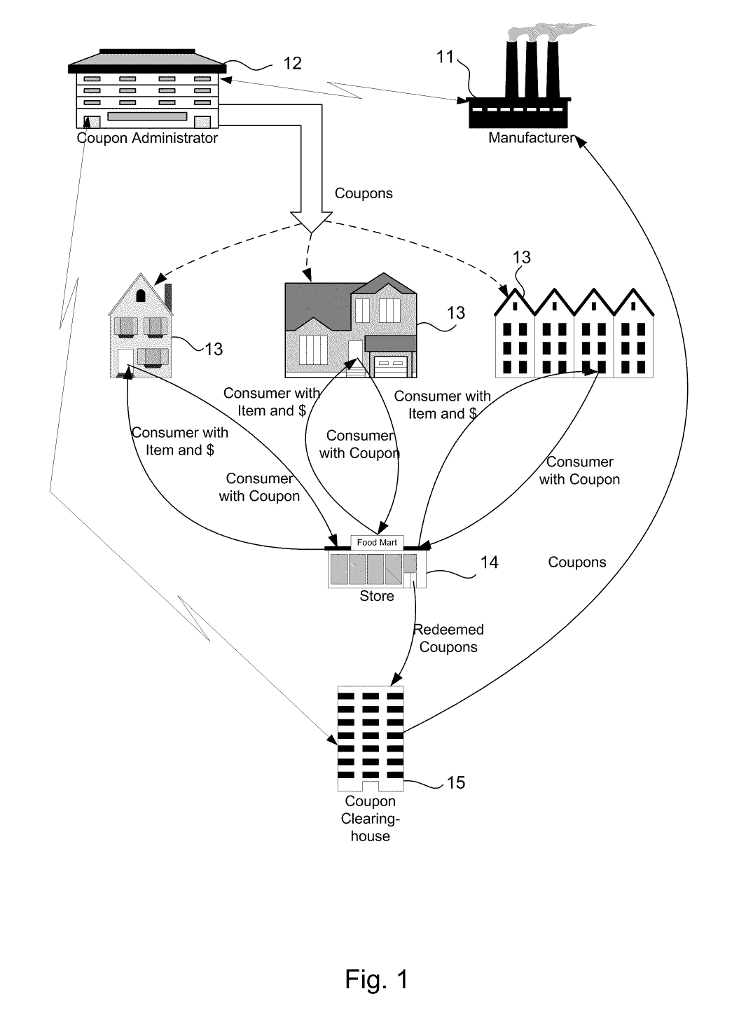

For an appreciation of the present invention by comparison, FIG. 1 illustrates the general participants and the activities related to the distribution and redemption of paper coupons as commonly practiced today. A seller of an item, such as a product or service, here shown as a manufacturer 11, engages a coupon administrator 12 to increase the sales of its products by issuing paper coupons in the name of the seller. Communication between the manufacturer 11 and the coupon administrator 12 is shown by the jagged double-headed arrow between the two symbolized entities. While a seller could mount its own coupon marketing campaign, the coupon administrator 12 is dedicated to that marketing business and is typically able to reduce costs by syndicating coupon production and distribution costs among several sellers. The coupons indicate the particular item(s) (by a combination of the manufacturer's identity code and a “family” code indicating a subset of items sold by that manufacturer), the redemption amount, either in the form of a discount in the price paid for the item or a cash refund, and oftentimes, the retail establishment, the store where the item is sold and the coupon honored.

The coupon administrator 12 then distributes paper coupons broadly, such as by newspapers or the coupon mailers. For example, the coupons are placed in the advertising sections of newspapers or sent indiscriminately by mail to consumers 13 (symbolized by the different housing in the drawing) in a particular location or region in packets of different coupons. The broad distribution of coupons is indicated by the broad arrow with the dotted arrows indicating the final delivery to individual consumers and households. There is no differentiation among the consumers 13. With the coupons in hand, the consumers 13 travel to one or more locations to purchase the items associated with the coupon and to redeem the coupon. The locations can be part of the seller or a separate entity, such as part of retail chain. In this example, the location is indicated as a retailer or store 14 which carries the coupon-related item for purchase. The consumers' activity is indicated by the arrows from the housing of the consumers 13 to the store 14. The typical point-of-sale (POS) equipment at the store 14 and possibly a retail person performs a check of the coupon and the purchased item for the validity of the redemption (i.e., that the coupon matches the item actually purchased, called the “validation” of the coupon). After the item is purchased by a consumer 13 and the coupon redeemed at the store 14, the consumer 13 having been compensated with the redemption amount (symbolized by the dollar sign) returns home with the item, as indicated by the arrows from the store 14 to the housing of the consumer 13. The redemption can be a discount in the price of the item at the store or a cash refund.

The store 14 sends the coupons it has redeemed and collected to a coupon clearinghouse, which typically processes the coupons of many sales and marketing promotions simultaneously. In some cases, the store 14 may send the coupons directly to the coupon administrator 12 or the manufacturer 11. In the latter case, the manufacturer 11 then provides the information from the coupons to the coupon administrator 12. The coupon clearinghouse 15 checks the coupons from the store 14 for forgery as best it can and sends information about the number of valid coupons, the product(s) they applied to, and their redemption value, and other relevant information to the seller/manufacturer 11 associated with the coupon of the marketing campaign. The coupon clearinghouse 15 might also send the information to the coupon administrator 12, though the details of the redemption information can also be provided to the coupon administrator 12 by the manufacturer 11. The coupon administrator 12 uses the information to report the details of the marketing campaign to the seller/manufacturer 11. In some cases, the coupon clearinghouse 15 forwards the coupons directly to another entity, such as the manufacturer 11, which performs its own checking and accounting of coupons. Though the coupon administrator 12 and coupon clearinghouse 15 are shown here as separate entities, both can be one entity. FIG. 1 illustrates the more general case where the two entities are separate. The coupon clearinghouse 15 may also manage the exchange of funds to process coupon redemptions by billing the manufacturer 11 for the value of the coupon and any processing fee and remunerating the store at which the coupon was redeemed.

General Operations of a Deferred Redemption Coupon System

The present invention provides a solution to the problem of fraud with paper coupons and their redemptions. With an initial redemption value of the coupon very small or even zero, there is little or no incentive for fraud in the redemption of the coupon. The incentive for the customer is tied to the value of the deferred redemption, which is personally tied to the customer. The coupon is still redeemed in the ordinary way so that the Point-Of-Sale (POS) equipment at the purchase location of the item, e.g., the retail store, still validates the coupon by the family and the manufacturer codes as in the case of an ordinary coupon. A coupon which does not match the item being purchased is rejected, and existing POS equipment can alert the cashier to not accept the coupon in question (or the cashier can note that the coupon does not match the items being purchased). Thus, the coupon utilizes the normal screening of the initial redemption value for the promoted item at the POS, but this first redemption amount is only a nominal amount which discourages fraud. Most (or all) of the value of the coupon comes from a deferred, second redemption amount which accrues to the customer who is identified by a special customer identifier on the coupon.

In order to receive the deferred redemption amount, the customer must have registered his or her name and address (or equivalent personal information, such as a bank account number) with the entity managing the coupon redemption, the coupon administrator, or a third party, an entity working with the coupon administrator to market the coupons. Where the third party has exclusive access to the true customer identity, an intermediate customer identifier is shared with the coupon administrator by which the coupon administrator can identify the customer for purposes of remuneration without knowing the details of the customer's identity. With the registration, an anonymous consumer becomes an identifiable customer. A customer identifier, such as a serial number, on the coupon provides a mapping from the coupon to the customer. The identifier is a unique number and is not typically generated by a calculable algorithm (i.e., it is effectively random, and only a table lookup can tie the number to the customer who earned the reward). Note that while each serial number may be unique, a set of serial numbers may all indicate the same customer so that one customer may receive multiple unique coupons that can all be tied to that customer. Additional attributes beyond just the customer identity can also be associated with and hence inferred from the unique serial number, such as the specific source of the coupon, the value of the coupon, the products or services associated with the coupon, and so on.

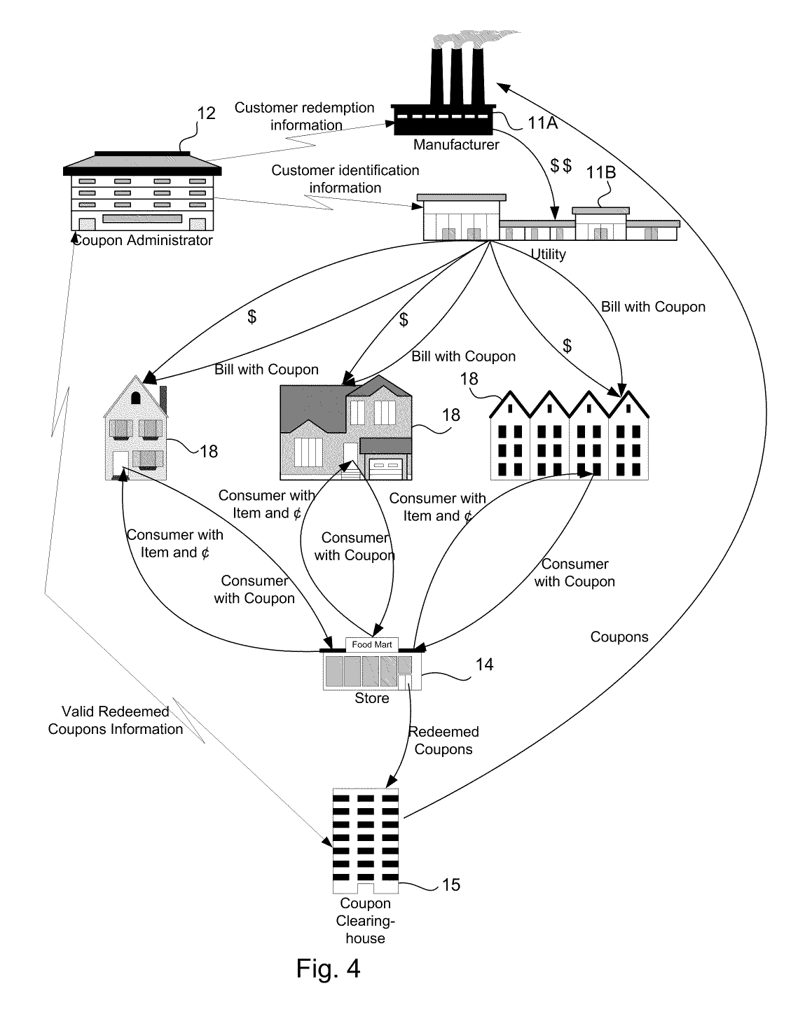

A full customer identifier can provide complete identification of the customer. An intermediate customer identifier provides partial identification of the customer. A complete identification is sufficient identification of the customer for coupon marketing purposes. This typically includes the name and an address, preferably a U.S. mailing address, and possibly other contact information, such e-mail address or telephone number, by which the customer can be contacted and remunerated. Thus a full customer identifier maps the coupon to a complete identification of the customer. On the other hand, a partial identification, as the term implies, provides for an identification of the customer, though not sufficient for all coupon marketing purposes. One example of partial identification is a customer identification number such as might be used internally by a separate entity (e.g., a partner of the coupon administrator) to identify a customer. Thus an intermediate customer identifier maps the coupon to a partial identification of the customer and requires at least one more mapping from the partial identification to a complete identification. Intermediate customer identifiers play a significant role in coupon marketing arrangement described with respect to FIG. 4 below.

When the coupon has been validated and cleared, the customer identifier provides the connection to the customer either to the coupon administrator directly, or to the third party entity which is assisting in the distribution of coupons. Having the coupon connection information, the third party, in turn, provides the information to the coupon administrator or provides a mechanism by which the coupon administrator may credit the customer associated with the customer identifier. The customer is credited the value of the deferred redemption amount of the coupon, and eventually is sent a check or is otherwise remunerated in some way by the coupon administrator—for example, in the form of a discount on products or services. The check may not be sent until a given “aspiration level” has been achieved—for example, the check might not be sent until the customer has earned at least $20 in deferred redemption amounts. This avoids expensive check processing and mailing costs from accruing from numerous and small individual deferred redemptions.

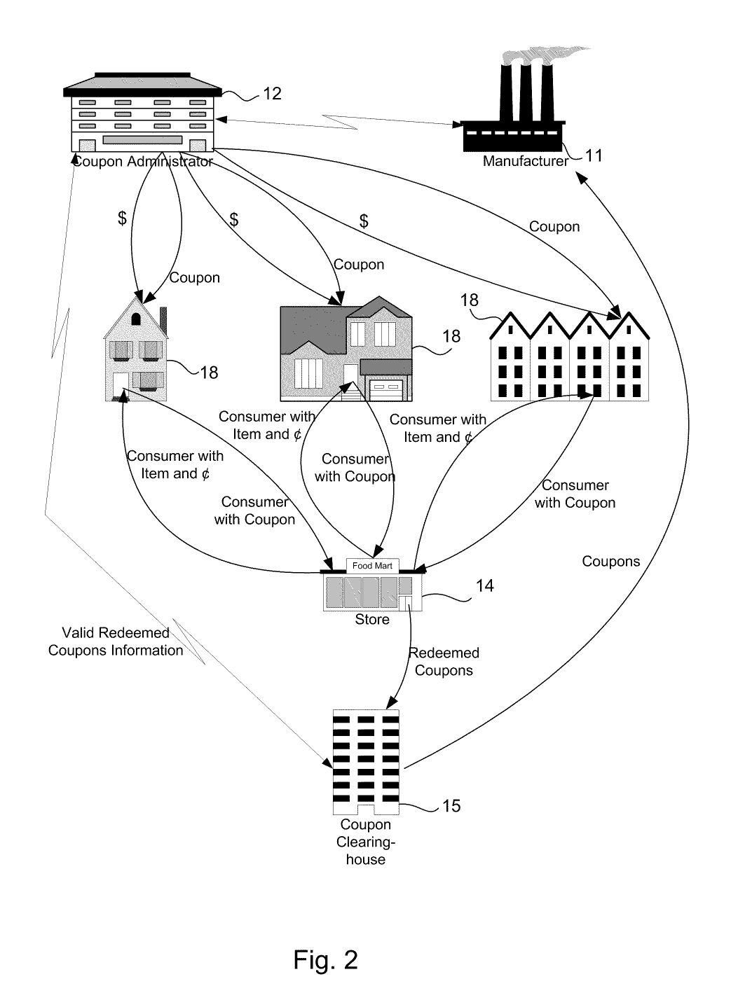

This aspect of the present invention might be best illustrated graphically. The participants and the activities related to the distribution and redemption of paper coupons in accordance to one embodiment of the present invention are shown in FIG. 2. Since the same participants are involved, most of the reference numbers are the same as in FIG. 1.

After being engaged by the seller of items, i.e., the manufacturer 11, the coupon administrator 12 distributes coupons to the customers 18. Since the customers are known and identified, a different reference number, 18, is used for customers, rather than 13 for the anonymous consumers. The coupons are distributed narrowly, rather than broadly. Each coupon is targeted to a specific customer, i.e., the customer is targeted to purchase one or more of the seller's items or engage some activity which is to the seller's benefit, such as to sample the seller's latest product. The family and manufacturer codes (in the item bar codes) on each of the coupons denote the seller and the particular item(s), which are also printed in plain language on the coupon, together with, optionally, the location where the item(s) might be purchased and the coupon redeemed. The two redemption amounts, the initial redemption amount which is minimal or even zero, and the deferred redemption amount which provides the true incentive for purchasing the item, are also printed on the coupon. If the initial redemption amount is zero, the coupon might simply state when and/or how the customer is to receive the (deferred) redemption. A customer identifier on the coupon ties the coupon to the targeted customer. In this example the customer identifier can be considered a full customer identifier. More details about the coupon are described below.

The coupon administrator 12 distributes each paper coupon to its corresponding customer 18. Distribution can be performed by various means, such as by direct mail or by allowing the customer to print an image of the coupon at home by the Internet. The print-at-home coupons, as well as the mailed coupons, have the customer identifier for that customer. No special print driver software or precautions to prevent the customer from downloading coupon images and editing them are required. The coupons of the present invention have no value to a forger or copier of the coupons. The targeted distribution of coupons is indicated by a first set of narrow arrows from the coupon administrator 12 to individual customers 18 and households. Though the drawing indicates the distribution of coupons from a single seller, manufacturer 11, in the simplified arrangement of FIG. 2, it should be understood that the coupons of several sellers are typically targeted to a customer 18. Thus a customer 18 might receive several coupons targeted to him or her, either mailed or available for printing over the Internet. The customer can directly select the coupons he or she desires, or the types of coupons or products he or she is interested in by the Internet.

With the received coupons, the customers 18 travel to the store(s) 14 to purchase the item associated with the coupon as indicated by the arrows from the housing of the customers 18 to the store 14. At the store 14, the item is purchased and the coupon is nominally redeemed by the first redemption amount. As stated earlier, there is little or no incentive to forge the coupon since the forged coupons have little or no initial redemption value. The coupon does have a significant deferred redemption value but that is tied to the customer through the identifier. Since the coupon is still redeemed in the ordinary way, a coupon that does not match the item being purchased will be rejected, and existing POS equipment will alert the cashier not to accept the coupon in question. Alternatively, the cashier might note that the coupon does not match the item being purchased. Thus the coupon discourages fraud because of the low or no value in the initial redemption amount and the coupon engages existing POS equipment and procedures to avoid fraudulent redemptions at a first level. A fabricated or duplicated coupon is thus of no value to a wrongdoer and a retail operator who might be hesitant to accept a coupon which appears printed non-professionally (e.g., on a home printer) should have no reservations in accepting a coupon which has little or no cash value at the cash register.

Having purchased the item and redeemed the corresponding coupon, each customer 18 returns with the item and the first redemption amount symbolized by the cent sign, indicated by the arrows from the store 14. The cent sign indicates the nominal value of the initial redemption amount. The store 14 sends the coupons it has collected and redeemed to the coupon clearinghouse 15 which checks the coupons for forgery and passes the coupon information which includes the customer identifier serial number and other information contained in the bar code(s), such as the coupon value, manufacturer code, family code and the like, to the coupon administrator 12. The coupon administrator 12 correlates the customer identifier serial number to both the initial (POS) and the deferred redemption amounts, as well as the customer account to which the deferred redemption amount must be credited. To do so, a table lookup is performed that obtains the coupon redemption values from the information provided by the coupon clearinghouse 15 (or, directly, by scanning the coupons if the coupon clearinghouse 15 provides the paper coupons directly to the coupon administrator 12). The manufacturer, family and value codes on the coupon should match the values associated with the customer identifier serial number.

Then the coupon administrator 12 credits the customer account tied to the customer identifier serial number with the deferred redemption amount in some manner. If the coupon clearinghouse 15 has not otherwise arranged to credit the retailer 14 for the initial (POS) redemption amount (if it is not zero), then the coupon administrator 12 must do this as well. The coupon administrator 12 informs the manufacturer 11 of the amount that is owed to cover the value of the coupon redemptions and bills the manufacturer 11 for this amount (along with any fees for providing the service itself). The manufacturer 11 generally transfers funds electronically to the coupon administrator 12, who in turn either credits the customers' accounts (or possibly a third party account tied to a customer 18 as described earlier). This last action is shown by the second set of narrow arrows with dollar signs from the coupon administrator 12 to individual customers 18 and their households. Thus the deferred redemption amount can be sent by a mailed check to the customer 18, a financial account belonging to the customer 18 might be credited, a discount in goods or services may be given to the customer 18, “points” may be awarded to a customer club account, and the like.

The coupon clearinghouse 15 uses information on the coupon, such as the indicia tied to the coupon administrator 12, any special manufacturer code associated with the coupon, the presence of a serial number (possibly in a specific range of serial numbers) or other information printed on the coupon, to determine that a coupon contains information that must be provided back to the coupon administrator 12. Information from ordinary coupons that is not associated with the coupon administrator 12 is not typically reported to the coupon administrator 12. In addition to the information gleaned from the bar codes on the coupon which carries the customer identifier serial number along with ordinary coupon details, such as the manufacturer code, family code, discount amount and so on, the coupon administrator 12 is generally able to obtain from the coupon clearinghouse 15, information of the store 14 or store banner where the coupon was redeemed and potentially information about when the coupon was redeemed. Other information can be inferred from information the customer provides during registration, such as the zip code of his or her residence, or by a survey presented to the customer. The set of information about the redemption by each customer can be analyzed to detect customer purchasing behavior and used to further direct targeting of coupons to individual customers. Some of this information may be used to enforce the parameters of the coupon—for example, if the coupon bar codes don't have automatically validated expiration dates, the cashier must enforce expiration dates in accepting the coupon. The approximate date of redemption, if known, can be used as an extra check that the customer is entitled to the deferred amount and was not redeeming an expired coupon. Of course, the serial number itself is checked to ensure that the serial number is valid and not duplicated. The other data can also serve as a check for attempted forgery—for example, by matching the serial number to the product code on the coupon.

Some of this information may be provided back to sellers, such as the manufacturer 11, to help them identify the characteristics of customers who respond to particular promotions. For example, a customer who redeems many types of baby product coupons may be inferred to have children. A manufacturer of cereal products is likely to have interest in how customers with children respond to a new type of cereal product. Thus direct customer selection or implied customer selection, such as the inferred customer's hobbies, pets and children, and home zip codes, help target promotions to the customers. Furthermore, because the identity of the redeemer of a coupon is known, additional direct marketing materials can be distributed to that person—for example, by mailing additional product information to the customer who redeemed a particular coupon. Along with such customer preference analysis, the coupon administrator 12 looks for patterns indicative of fraud, such as redemption in stores where the product associated with the coupon is not stocked, or for heavy patterns of redemption that may indicate “stuffing” behavior which should be investigated further.

Examples of the Targeted, Deferred Redemption Coupon

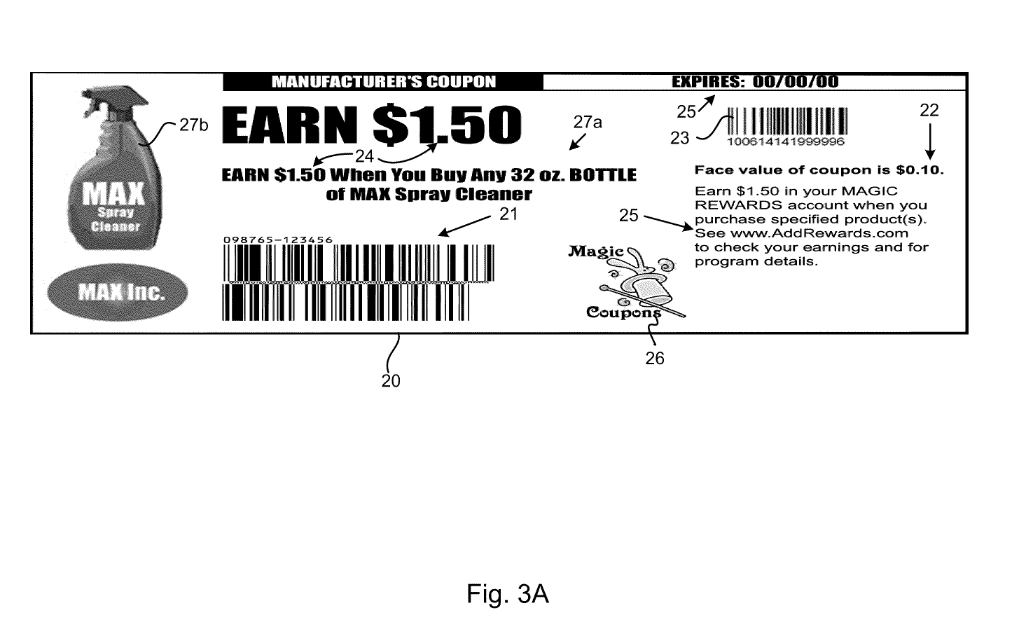

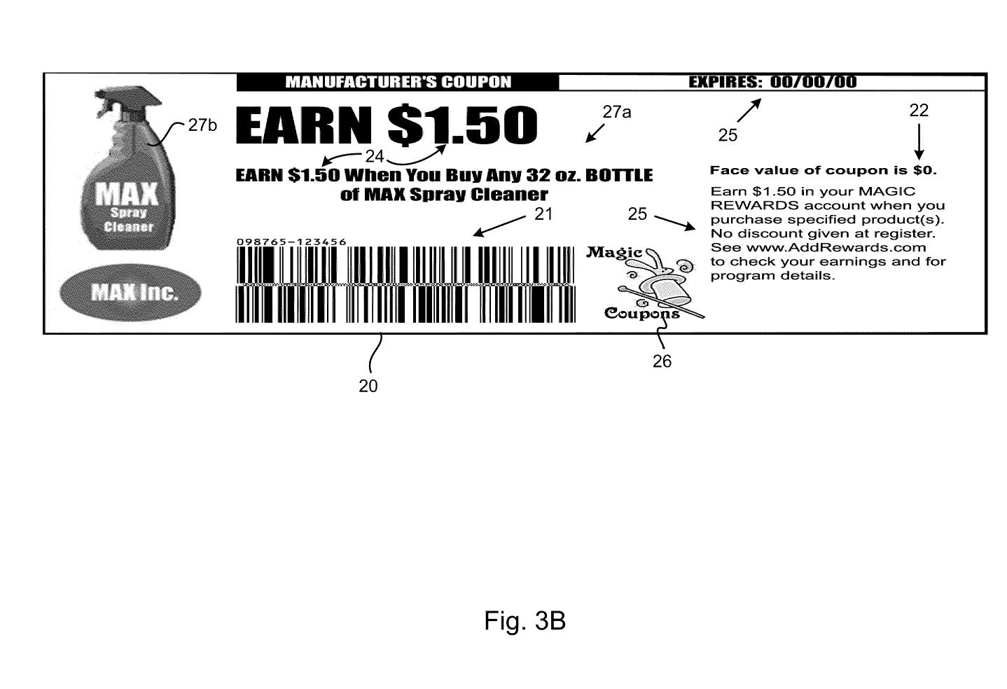

FIG. 3A is an example of the face of a coupon according to one embodiment of the present invention. On the coupon paper substrate 20 there is a printed description 27a of the item 27 or even a depiction 27b of the item 27. The coupon substrate 20 also has an item bar code 21 which identifies the item 27 and optionally the retailer at which the item is to be sold, along with other conditions, such as the redemption value 22 (of the initial redemption amount) of the coupon at the retail store register, the expiration date, and other limits. The initial redemption amount 22 is printed on the coupon (which may be zero). The coupon may have printed instructions, locations or limitations 25 of where and how the coupon is to be redeemed, such as the store(s) 14 of FIG. 2 and the like. The coupon may also have unique indicia (such as a distinctive “Magic Coupon” logo 26) to draw attention to the particular nature of the coupon. The indicia are not related to the particular coupon offer but indicate that the coupon is a deferred redemption coupon and that the initial redemption amount is either a small amount or zero. If a customer attempts to redeem a forged coupon with an amount of the first redemption amount coupon more than nominal, i.e., a small amount (or zero), then the store or retail establishment is alerted to that fact and should reject the coupon.

The deferred redemption amount 24 is also printed on the coupon along with a customer identifier 23 which is associated with the customer to whom the coupon is targeted for the purchase of one or more specified items. The customer identifier 23 can be embedded within a GS1 DataBar Expanded format which can encode additional GS1 Application Identifiers (up to 74 characters in length), such as a sell-by date, serial number and other parameters, a two-dimensional bar code (if other formats such as UPC-A (Universal Product Code A) which do not allow a serial number to encode the coupon are used), any type of scannable bar code, or even a simple serial number. The customer identifier Application Identifier, two-dimensional bar code, scannable bar code or serial number is separate from the normal item coupon bar code 21 on the coupon. The identifier 23 should not mistaken for, and be interpreted as, the item bar code 21 at the POS. Hence, if a customer identifier is implemented outside of the GS1 Databar protocol, for example, the barcode technology used should not be recognized by the ordinary retailer POS equipment.

With the GS1 Databar coupon format, the coupon administrator 12 can be designated as the primary manufacturer by indicating the coupon administrator 12 as the primary vendor with a purchase requirement of zero and a savings of zero. The manufacturer who is actually sponsoring the coupon is designated as the secondary vendor with the appropriate purchase requirement (typically one item, but there could be more indicating that more than one item must be purchased to validate the coupon) and a savings of zero (or a small amount) for the initial redemption. This allows the coupon administrator 12 to receive all of the information about the coupon redemption from the coupon clearinghouse 15 without having to obtain the information from the manufacturers who are normally supplied the coupon clearinghouse 15 information based on the manufacturer code embedded in the coupon. Thus, the coupon administrator 12 is able to relieve the manufacturers of some of the burden involved in coupon clearing and accounting. Of course, the GS1 Databar may also be used with simply one manufacturer (the actual manufacturer of the product) in which case the manufacturer may have to report redemption information back to the coupon administrator depending upon the capabilities of the coupon clearinghouses.

FIG. 3B illustrates a coupon in which the initial redemption amount 22 is zero and the customer identifier 23 is embedded in the item bar code 21. In this case, when the bar code 21 is scanned, the identifier 23 is also scanned though the information from the identifier 23 is extraneous. The ordinary POS equipment does not respond to this extra information. On the other hand, scanning equipment adapted for the extra information in the enlarged bar code 21 can read the information of the identifier 23. The customer identifier 23 identifies the coupon item(s), the seller of the item(s) and, in particular the customer to whom the coupon is directed. The customer is typically known to the coupon administrator by a registered name and address, or some personal information, such as a bank account number, a credit card account number, a customer or account number of a third party, a loyalty card account number for the retailer or manufacturer, or a loyalty card accumulate account as described in U.S. application Ser. No. 10/778,611, filed Feb. 12, 2004 and assigned to the present assignee, and incorporated herein. The customer identifier 23 encodes a serial number which uniquely maps to the customer-identifying information. It should be noted that not all of these mappings are directly to the customer and in some cases there is only a limited direct identification from the identifier/coupon to the customer, i.e., the mapping from the customer identifier 23 to the customer is an intermediate mapping to provide additional protection of the customer's identity. At least one more mapping is required to obtain the customer's identity. In any case, the customer must have registered or provided their name and address (or some equivalent personal information) so that the coupon can be tied to the customer, and the coupon can be delivered to the customer, and that therefore the deferred redemption amount can be passed on or credited to the customer in some fashion.

Deferred Redemption System with a Third Party Seller's Customers

The deferred redemption coupon system is versatile and can be employed in different arrangements. For example, the value of the deferred redemption for the purchase of a seller's item(s) can be credited to the consumer as a discount or “points” for a third party's goods or services. A third party who mails a consumer some item regularly, such as a bill or a product ordered on-line, can benefit from mailing a deferred redemption coupon for a seller's item with the third party's product or service. Alternatively, the third party or the coupon administrator 12 could mail the deferred redemption coupon directly to the third party's customer base, preferably using mailing vehicles branded with the insignia of the third party. Alternatively, the third party's website can be connected to the coupon administrator 12's infrastructure to allow for customers to receive print-at-home coupons from the Internet when using the third party's website. In return for helping the sales of the seller's coupon-marketed item, the seller pays for the third party's product or service to the customer, the deferred redemption amount. In contrast, with a conventional coupon, the third party has no incentive to include the seller's coupon with the third party's product offering (unless paid directly to perform this service) since the coupon when redeemed, provides only a redemption value to the consumer and sales to the seller.

An example of such an arrangement is illustrated graphically in FIG. 4. In this case, the customer base of the third party, here shown as a utility 11B, is solicited by the seller, shown as manufacturer 11A. Since the customer base of any business is extremely valuable, a third party will not ordinarily reveal its customers to the seller, nor will the utility 11B reveal its customers to the manufacturer 11A. Instead, to protect the identity of the customers, the third party/utility 11B creates an intermediate identifier for each of its customers 18. The intermediate identifier maps to its customers 18 and that mapping via a lookup table is available only to the utility 11B. The complete identity of each customer 18 is thus unknown to the manufacturer 11A, nor to the coupon administrator 12. The intermediate identifiers are used by the coupon administrator 12 as a partial identification of the customers and each customer identifier on a deferred redemption coupon is mapped to an intermediate identifier from the utility 11B.

Distribution of the coupons is complicated by the presence of the third party, the utility 11B in the example of FIG. 4, so that the identity of the customer associated with the serial numbers of the delivered coupons is preserved. Furthermore, though only a single coupon of the manufacturer 11A has been described mailed with the mailed bills of the utility 11B, a more likely targeting arrangement is the distribution of a set of coupons from different sellers with the third party's goods or information (such as special offers or bills) to a particular customer.

A first distribution method which facilitates coupon distribution through a third party, such as the utility 11B, identifies each coupon of a set with a unique bar-code identifier, which is also on the coupon set mail packet, to track the coupons. The third party scans the bar code on a coupon packet for a particular customer and then retrieves the customer's intermediate identifier before mailing the third party's package of goods or information with the coupon packet to the customer. The information comprising the intermediate customer identifier and the coupon packet identifier is then sent to the coupon administrator 12. The coupon administrator 12 then knows which coupons were sent to a specific customer and can track the rewards due that customer by associating the coupon packet identifier serial number on the coupon to the intermediate customer identifier that is associated with the identifier on the packet of coupons. In effect, the coupon packet identifier is a customer identifier through the mapping to the intermediate customer identifier. In this case, coupons are effectively broadcast-distributed to the third party's customer since the third party does not know which packet went to which customer. A second distribution method has the coupon administrator 12 pre-print the intermediate customer identifier on the packet of coupons for a customer and direct the third party seller to package those coupons only with shipments for that customer. However, this requires extra effort to select the correct packet from potentially many coupon packets to send to a customer. This method permits the coupon administrator 12 to target customers as discussed previously. A third distribution method relies upon the coupon administrator 12 having obtained the intermediate customer identifiers from the third party and some purchasing patterns of the customers from tracking the intermediate customer identifiers. The coupon administrator 12 can then target specific coupons to specific customers through their intermediate customer identifiers. When the third party is ready to mail a coupon packet to a specific customer, the third party notifies the coupon administrator 12 of that fact, i.e., a request for information, and the coupon administrator 12 transmits coupon information for that customer to the third party. From that information the third party prints the correct set of coupons to include in the coupon packet to send to the customer. Alternatively, having obtained some understanding of the customer behavior through previous coupon marketing campaigns, the coupon administrator 12 in a fourth distribution method targets the customers by purchasing interests or tendencies and prepares several different sets of coupons of likely item purchases (e.g., one set for families with pets, another set for families with children, and so on). The intermediate identifiers are used to identify the customers. The third party, when preparing a mail package to one of its customers, retrieves information from the coupon administrator 12 or from a set of data maintained by the coupon administrator 12 as to the type of packet to best target that customer. Each coupon in a packet has a coupon packet identifier. The third party can record the coupon packet identifier of the packet sent to the customer and the intermediate customer identifier of that customer and transmit that recorded information to the coupon administrator 12 for tracking purposes. The packets can be color-coded, bar-coded, or otherwise marked, as to which class or segment of customers should receive a particular set of coupons easily select the correct packet to bundle with the third party's mail package.

These distribution methods should not be considered as necessarily static implementations. That is, the third party might distribute the sellers' coupons in one way at the beginning of the relationship with the seller(s) and then change the distribution method as more knowledge is gained about the customers. For example, the utility 11B of FIG. 4 can distribute initially coupons of the manufacturer 11A using the first distribution method with the coupon packet identifier and the intermediate customer identifier. Then with more knowledge of the buying habits of the customers, the fourth distribution method can be used to better target the customers. Finally, the second third distribution methods permit finer customer targeting with better customer knowledge.

Furthermore, rather than relying upon the protection of the intermediate identifiers, the third party seller/utility 11B may have some relationship with the coupon administrator 12 and “trust” the coupon administrator 12. Instead of the intermediate identifiers, the customers can be identified by their names only or be completely identified by their names and addresses. As the coupon administrator 12 is able to identify the customers of the third party/utility 11B more completely, the coupon administrator 12 is able to assume more of the responsibility and work from the third party, such as the utility 11B, in the distribution and redemption of the targeted coupons.

Returning to the operations of FIG. 4, the deferred redemption coupons invite the customers 18 to purchase items from the seller, the manufacturer 11A, or engage in some activity, such as to test drive the seller's latest model automobile. In return, the customer 18 receives an initial redemption amount redeemable at a store 14 which sells the items, or is a site for the seller's activity. The amount of the first redeemable amount is nominal, or even nothing, as symbolized by the “¢” symbol. On the other hand, the value of the deferred redemption is considerable and is in the form of goods or services provided by the utility 11B.

The customers 18 redeem their coupons upon purchasing the manufacturer's items at the store 14 and the redeemed coupons are transferred to the coupon clearinghouse 15. As described earlier, after the coupon clearinghouse 15 (or possibly the manufacturer 11A) validates the redeemed coupons and reports information including the customer identification serial number, to the coupon administrator 12. The coupon administrator 12 determines the deferred redemption amounts for the customers 18 and the coupon administrator 12 informs the manufacturer 11A of the amount the manufacturer 11A should pay the utility 11B for the deferred redemptions. These deferred redemption amounts to the customers 18 may be in the form of items at list or discounted prices, financial account credits, “points” or even cash from the utility 11B, all of which is symbolized by the dollar sign next to the arrows from the utility 11B to the customers 18. Thus, the first seller (the manufacturer 11A) of the deferred coupon effectively pays the third party (the utility 11B) for the third party's products or services. This payment is indicated in the drawing by a double dollar sign. In this example, the customers 18 may receive a discount on the utility's products or services, the manufacturer 11A receives the benefit of the advertising and additional sales associated with the coupon redemption and the utility 11B has an extra boost of products or services sold. While the utility 11B ordinarily might have no incentive to distribute coupons for another party, the deferred redemption coupons allow a mutually beneficial arrangement for the two sellers, the manufacturer 11A and utility 11B.

Computer Network for Targeted, Deferred Redemption Coupon System

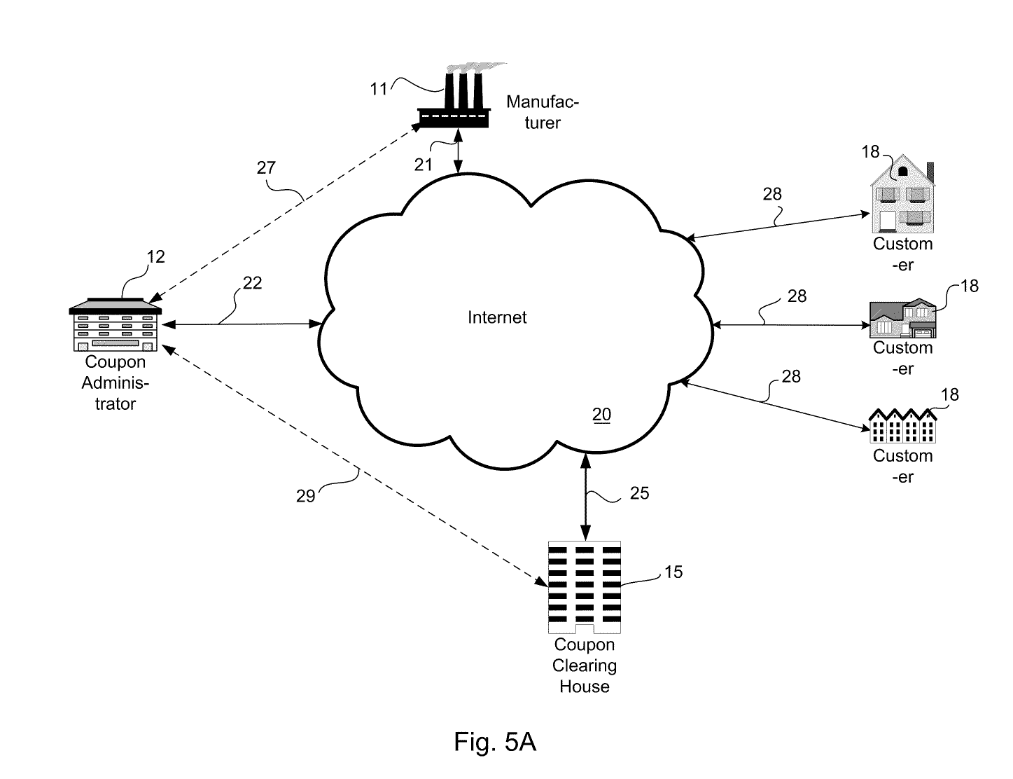

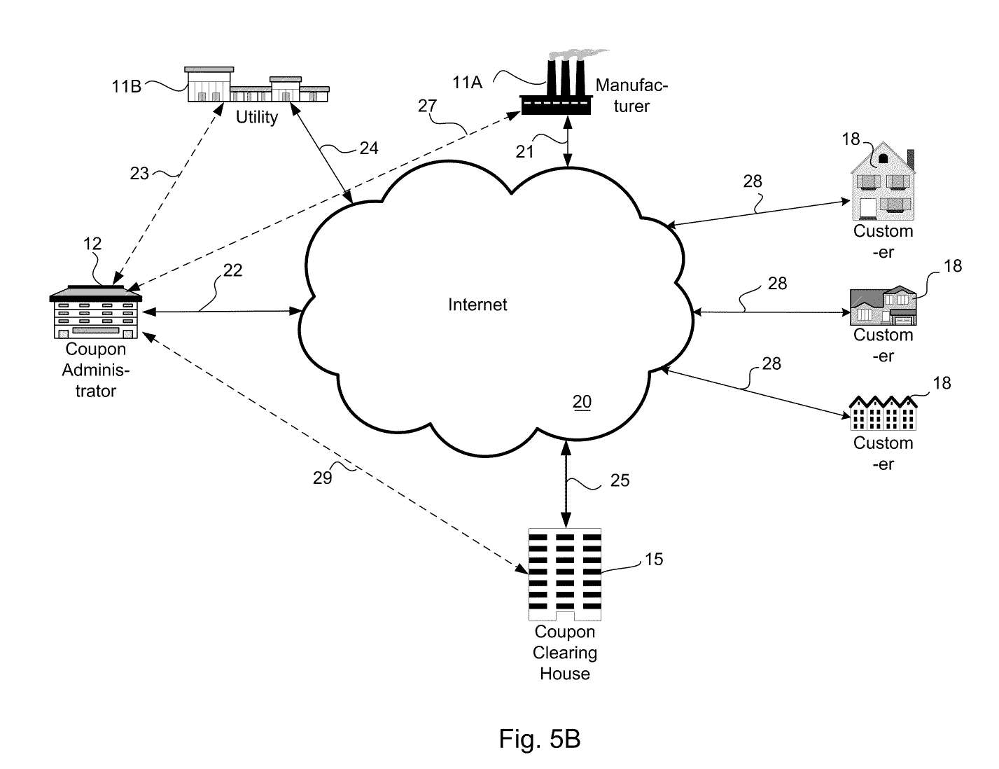

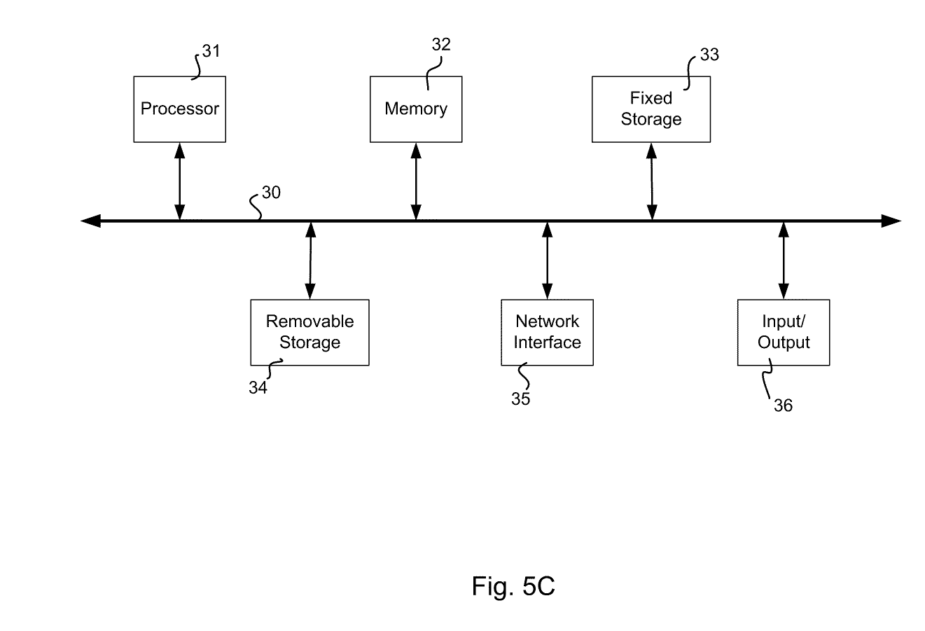

FIGS. 2 and 4 illustrate the transactions among the parties, i.e., seller (manufacturer), coupon administrator, coupon clearinghouse and third party (utility), and the customers 18 in various arrangements of the targeted, deferred redemption coupon system of the present invention. FIG. 5A is a diagram of computer networks which interconnect the parties and the customers for carrying out the operations of the FIG. 2, according to one embodiment of the present invention. FIG. 5B is a diagram of computer networks which interconnect the parties and the customers for carrying out the operations of the FIG. 4, according to an embodiment of the present invention.

FIG. 5A illustrates the electronic communication paths among the manufacturer 11, coupon administrator 12, the coupon clearinghouse 15 and the customers 18 through the Internet 20. The solid double headed arrows 21, 22, 25 and 28 for the manufacturer 11, coupon administrator 12 coupon clearinghouse 15 and customers 18 respectively indicate the bidirectional flow of information between each of these entities and the Internet 20 as described herein. For the coupon administrator 12 to communicate with the manufacturer 11, for example, information is passed through the Internet 20 which acts as the “medium” between the communicating entities. Alternatively, for security purposes private networks can be used between the manufacturer 11 and coupon administrator 12 as indicated by the dotted arrow 27 and between the coupon administrator 12 and the coupon clearinghouse 15 as indicated by the dotted arrow 29.

FIG. 5B illustrates the electronic communication paths for FIG. 4. The paths are shown as the same as in FIG. 5A, except that with the addition of the utility 11B there is a bidirectional path 24 between the utility 11B and the Internet 20. There is also an alternate private network path 23 between the utility 11B and the coupon administrator 12.

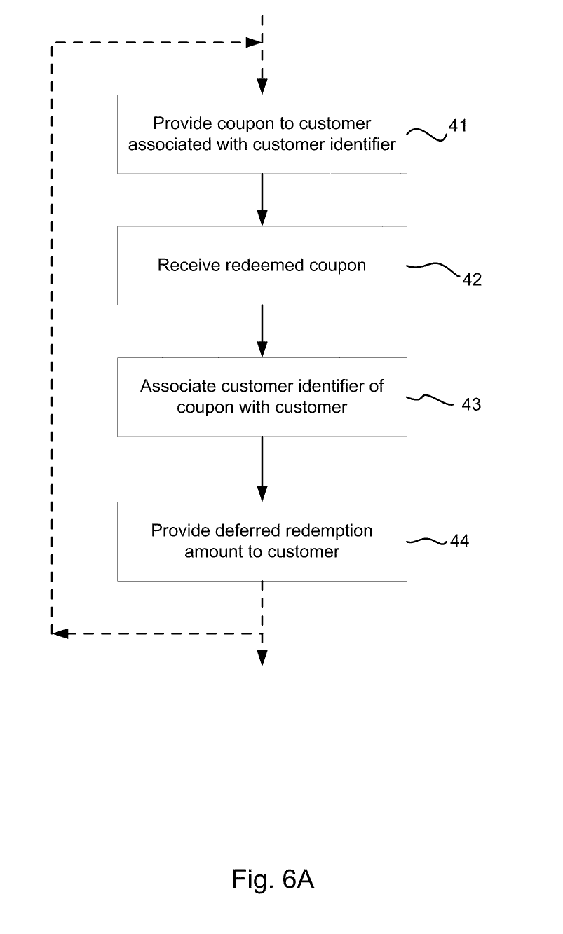

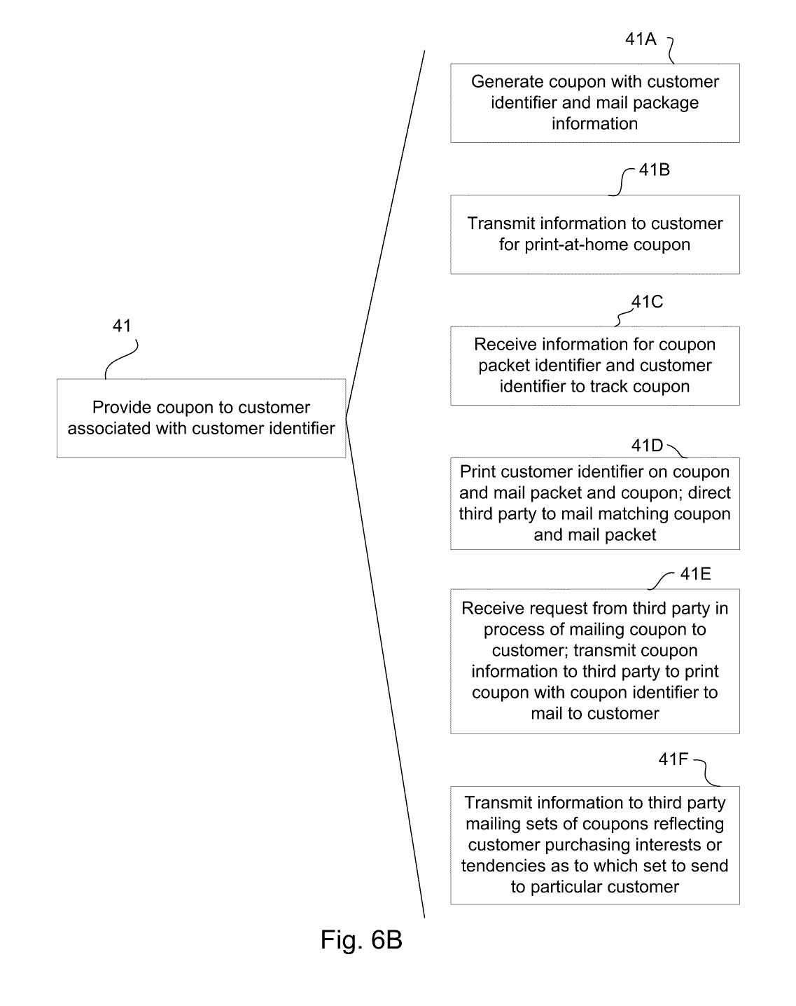

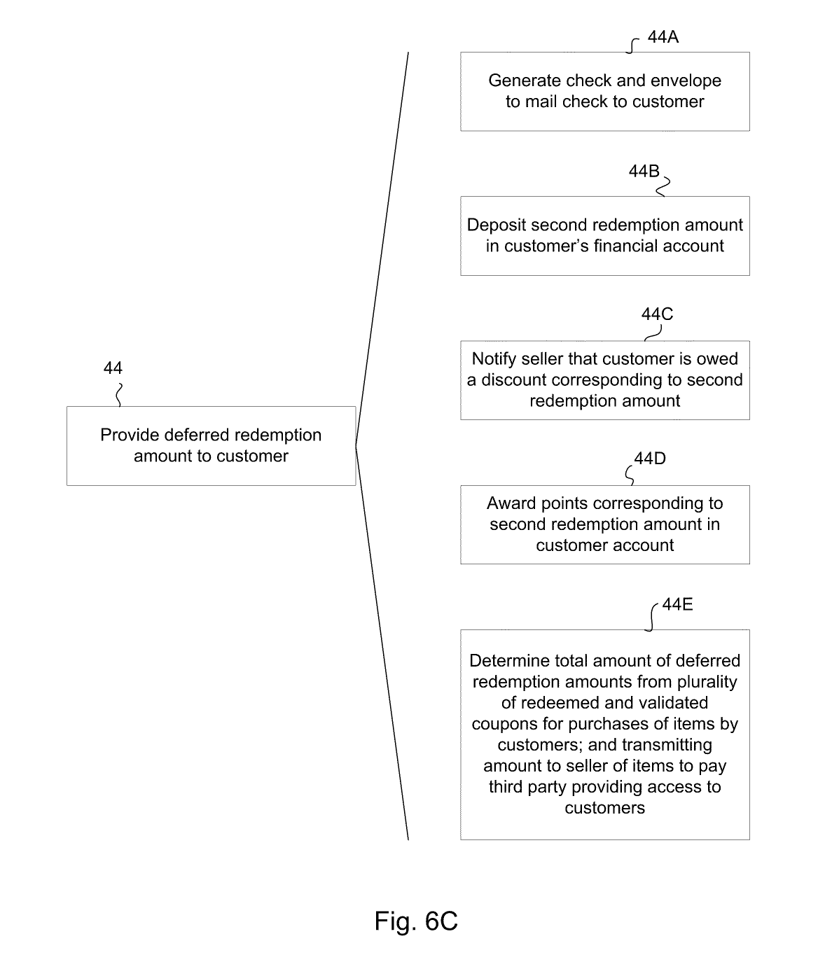

For the entities above to communicate electronically and to carry out their operations, each has a computer system which is connected to the computer systems of the other entities via the described networks and which performs many of the previously described operations. FIG. 6 is a block diagram of a typical computer system. The computer system has at least one processor subsystem 31 which is connected to a system bus 30 and a memory subsystem which includes memory 31, fixed storage memory 33 and removable memory storage 34. The processor subsystem 31, among other functions, processes the instructions and data of computer code, and can include more than one processor unit, such as in a multi-processor system. The memory subsystem stores and retrieves software programs incorporating computer code that implements aspects of the targeted, deferred redemption coupon system of the present invention, data for use and the like. Computer readable storage media for the memory subsystem include semiconductor system memory and flash memory (memory 32), though other storage media, such as hard drive (fixed storage memory 33), CD-ROM, floppy disk, and tape (removable storage memory 34), might be used. A network interface 35 provides a pathway for the computer system to communicate over the previously described network system and an input/output subsystem 36, including a keyboard, display, printer and the like, allows a human user to interact with the computer system. All of these elements are interconnected by the system bus 30.

While the computer system has been described above as a unitary system, the computer system of one or more entities of the targeted, deferred redemption system can be organized as a distributed system, such as found in grid computing or even cloud computing. That is, rather than a single, tightly coupled unit, one or more computers (and even the elements of a computer) can be loosely coupled over one or more networks. The elements of the computer system whether tightly or loosely coupled, are configured to perform the operations of the targeted, deferred redemption system elements, one of which is the coupon administrator.

Computer System Operations of the Coupon Administrator

The coupon administrator 12 performs many operations in the targeted, deferred redemption coupon system as previously described and many of the coupon administrator's operations can be performed by its computer system. FIG. 6A is a flow chart of basic operations by the computer system of the coupon administrator 12 which is configured to perform these operations. The dotted arrow from the top indicates that the described steps occur after other operations of the computer system, such as initialization. In step 41 the coupon administrator 12 provides a coupon to the customer associated with his or her customer identifier. This distribution of a coupon to a customer can be done in many ways. For the arrangement described with respect to FIG. 2, step 41 comprises generating the coupon with customer identifier and mail package information so that the coupon can be mailed to the customer or transmitting information to the customer for a print-at-home coupon. The coupon has the customer identifier. These examples of step 41 are illustrated as steps 41A and 41B respectively in FIG. 6B.

For the arrangement described with respect to FIG. 4, the coupon distribution of step 41 might entail receiving information from the third party of the coupon packet identifier for a coupon mailing packet in which the coupon was mailed to the customer and of the customer identifier on a coupon (e.g., the serial number portion of the barcode) from the packet. This allows the coupon to be tracked by the customer identifier. This is represented by step 41C in FIG. 6B. Step 41 might also comprise printing the customer identifier on a coupon mailing packet which includes the coupon and sending instructions to the third party to mail the coupon mailing packet to the customer so that the customer identifier on the packet and the customer identifier encoded on the coupon match. This is represented by step 41D in FIG. 6B. Step 41 might also comprise receiving a request from the third party in the process of mailing a coupon mailing packet to the customer and transmitting coupon information to the third party so that the party can print out the coupon including a customer identifier for the customer to mail in the coupon mailing packet. This is represented by step 41E in FIG. 6B. Step 41 might comprise transmitting information to the third party mailing different packets of coupons to different customers to direct which set of coupons to send to a particular customer to best target the customer. Each type of packet of coupons reflects customer purchasing interests or tendencies and each coupon in a packet has the same coupon packet identifier. Step 41F in FIG. 6B represents this example of step 41 in FIG. 6A. Upon receiving information from the third party of the correspondence of the customer identifier to the coupon packet identifier on a mailed coupon, the coupon administrator computer system can track the coupon to the customer. In most of these FIG. 4 arrangements the customer identifier is intermediate to provide only a partial identification of the customer, as described earlier.

In step 42 of FIG. 6A the coupon administrator 12 receives the redeemed coupon from the coupon clearinghouse 15. While the redeemed coupon, along with many others, can be received physically from the coupon clearinghouse 15, the computer system receives the electronic data gleaned from the coupon by the coupon clearinghouse 15 as it validates the coupon. The computer system of the coupon administrator 12 associates the customer identifier on the coupon with the customer in step 43 by correlating the customer identifier to the customer through a look-up table, as described earlier. In the FIG. 2 arrangement, the customer identifier is complete and the process proceeds to step 44 by which the computer system provides for a second redemption amount to the customer. Examples of step 44 are shown in FIG. 6A. The computer system can generate a check and mailing envelopes for a direct mailing of a redemption amount check to the customer (step 44A), deposit the second redemption amount in a designated financial account of the customer (FIG. 44B), notify a third party that the customer is owed a discount in goods or services corresponding to the deferred redemption amount (FIG. 44C), award “points” corresponding to the deferred redemption amount in some customer account (FIG. 44D), and the like, again as previously described. In a FIG. 4 arrangement step 44 might have the coupon administrator computer system determine the total of deferred redemption amounts from the redeemed coupons validated by the coupon clearinghouse 15. The coupon administrator computer system then transmits the total to the seller (manufacturer 11A) for the seller to pay the third party (utility 11B). This example is illustrated as step 44E in FIG. 6C. The seller may also directly remunerate the coupon administrator who in turn remunerates the third party.

Then the process returns back to step 41 for another coupon, or the computer system continues on to other tasks. For the arrangement described with respect to FIG. 4, typically the customer identifier on a coupon is an intermediate identifier which avoids a complete identification of the customer, as explained earlier.

It should be noted that the initial redemption value can be validated by a retailer, the store 14 in the examples of FIGS. 2 and 4, without relying on the point of sale system (POS) to automatically validate bar codes against actual purchases. As an example, a dry cleaner may accept from a customer a deferred redemption coupon that does not have a bar code for the initial redemption amount (although there is a bar code for the serial number tied to the identity of the customer). In this case, the retailer 14 (dry cleaner) might not employ the services of a coupon clearinghouse 15 and instead, send the coupon directly to the coupon administrator 12. The retailer 14 may also process any initial redemption value by hand, without reliance upon the actual POS hardware to adjust tender totals for the customer, or by entering the amount of the initial redemption value by hand into their POS system (i.e., without relying on a bar code for the initial redemption amount).

Resulting Advantages Over a Conventional Coupon System

The present invention addresses fraud, including that of coupon clearinghouses, by minimizing or eliminating the face value of the coupon which is the target of many forms of coupon fraud.

It is difficult to cheat the described coupon redemption system. It is virtually impossible to guess a valid customer identifier number, and a forged coupon is worth very little at the POS. Even if a valid identifier number were guessed, it is of no value to the guesser since the deferred redemption accrues to the customer, not the guesser. A customer might give his or her coupon to someone else, who can only receive the nominal initial redemption amount by buying the item with the intended result (someone buys the item) and the value of the deferred redemption amount is earned by the customer. Forgery is not a problem. Since the initial redemption amount is nominal, the retailer or store loses very little or nothing and the customer gains very little or nothing, as long as the coupon has been checked at the POS or cashier to simply match the purchased item. As described earlier, the coupon has a distinctive look to alert the POS/cashier that the coupon at hand is not an ordinary coupon and that the initial redemption amount has little or no value.

Note that the retailer or store must take extra steps to defeat a consumer who forges a conventional print-at-home coupon even if that coupon bears a serial number because a reasonable facsimile of a serialized coupon with a false serial number can be fabricated easily. The retailer or store can contact the entity managing the coupon campaign to inquire whether the serial number on the coupon is valid, or can modify its POS equipment to automate such queries to a remote database of valid serial numbers. The first is highly unlikely due to time constraints on most retailers to close a sale, and the second would require significant modification of retailer POS software and standardization of the protocol used to validate the extra information on the coupon. Each alternative costs the retailer money either in the form of lost sales from disgruntled customers who are tired of waiting, or investment costs in new POS equipment and in lost time to get the new equipment operational. The current invention requires no modification of the POS or the real-time network connection to ensure validation since a copied or forged coupon does not benefit the customer who tenders it. When the coupon is cleared, the customer to whom the coupon was issued (who is known by the unique customer identifier on the coupon) is credited only once. A forger might attempt to create coupons with valid identifiers, but there is no benefit in doing so. The forger cannot tie the created identifier to himself since he has no access to the identifier/customer lookup table. By using large random numbers for the deferred redemption coupon's unique customer identifiers, even this remote possibility is mitigated.

The present invention is vulnerable to one type of fraud. In this case a shopper attempts to redeem valid coupons and receive the deferred redemption amounts for items not actually purchased. At regular check-out lanes, this requires collusion with the POS checker to accept a coupon without validating, i.e., by scanning, it. At a self-checkout (SCOT) lane, a shopper might succeed in placing the coupon in the till (without receiving the immediate redemption amount) and not purchase the required item. But unlike a forged normal paper coupon, the identity of the shopper “stuffing” this coupon is known to the coupon administrator. This type of gamesmanship can only benefit the customer to the coupons were issued—a coupon clearinghouse attempting large-scale fraud based on obtaining large numbers of valid but unredeemed coupons will not be able to extract value from these types of coupons. Shoppers who have an unusual pattern of redemptions may be requested to provide proof of purchase (e.g., receipt copies) in order not to be terminated from the program. Furthermore, a modern SCOT terminal which validates coupons in a manner similar to dollar bill changers could be set to only accept coupons that are scanned and validated. Once potential fraud is detected, the shopper's account can be frozen and the shopper notified that there is suspicious activity on the account. If the shopper can provide receipts, the account can be unfrozen. It should also be noted that the retailer does not suffer from this type of fraud since nothing is given to the shopper at the POS. Finally, it is impossible to syndicate this kind of fraud (e.g., by publishing and sharing fake coupons). Only the individual shopper may attempt this. It is not a type of fraud that can be committed at a regular non-SCOT lane with an honest checker, unlike fraud with normal paper coupons including print-at-home coupons.

A common practice of coupon thieves at SCOT terminals is to scan a paper coupon multiple times, even though the user possesses only one physical coupon. The store pays the customer the face value of the coupon, but because the physical copy of the coupon is not tendered, the store has no proof of coupon use to present to the Consumer Packaged Goods Manufacturer (CPG) in order to be compensated for the coupon's face value. Any coupon, including print-at-home coupons, can be used in this way to effectively steal money from the store. Such a practice is not possible with deferred redemption coupons. In addition, with deferred redemption coupons, very little or no cash leaves the POS. Thus coupons can be issued to customers without the retailer handling cash in large amounts for redeeming coupons. For example, a customer may be nicely rewarded by the deferred redemption for taking a test drive and the car dealer need not worry about cash management to reward the customer for an immediate redemption.

With the deferred redemption coupons, the customer's purchasing behavior can be tracked and rewarded in ways beyond those of conventional coupons. Even with print-at-home coupons with tracking serial numbers, a customer can be rewarded over time only with another coupon, good for some discount on a product. This severely limits the attractiveness of the reward. With the coupons of the present invention, the customer can be rewarded with cash, services or products of significant value. Thus, a longitudinal marketing program, such as rewarding customers for purchasing a number of manufacturer's products over an extended period of time, can be implemented easily with deferred redemption coupons. As an example, a customer who purchases 10 different boxes of cereal over the course of a year might receive an increment to his account of $20. With traditional coupons, even those with customer tracking capabilities, the best that can be done in this situation would be to issue a coupon good for a discount. It is not possible to have a $20 discount on a single box of cereal. Coupons good for cash are highly suspect by retailers and are unlikely to be accepted because of the risk of counterfeiting and the high cash value of the coupon. This technique is an example of how longitudinal credits or “points” can be earned as a result of redeeming deferred redemption coupons. “Points” are redeemable in a variety of ways—for example, by simply adding to the value of the amount of the check mailed to a customer or by increasing the discount on the goods or services to be discounted. Points may also be redeemable for other products or services.

A customer may be invited to select a set of deferred redemption coupons that most interest the customer. This selection could be performed typically on a computer over the Internet, but could also be done at a kiosk, or by other device. If targeting is possible at the individual customer level in the distribution method employed (e.g., where the coupon administrator directly mails coupon packets to the customer or the coupon administrator is able to specify the coupon packet identifier to be sent to a given customer through a customer identifier associated with a third party), then the selection can be implemented and the customer can receive a set of coupons that are particularly relevant to that customer.

It is apparent from the foregoing that the present invention prevents or substantially reduces the amount of fraudulent coupons with a flexible and adaptable system of targeted, deferred redemption coupons. Furthermore, third parties are allowed to benefit from the distribution of coupons for the good and services of other entities in terms of direct returns and from closer relationships with the third party's customers. Cash management for coupon redemptions is simplified. The foregoing include some of the advantages and benefits of the present invention.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A coupon comprising:
a paper substrate;
a customer identifier on the substrate, the customer identifier associated with a particular customer;
a description of one or more items on the substrate;
a first redemption amount on the substrate for redemption upon purchase of the one or more items and tender of the coupon at a point-of-sale (POS) system; and
a second redemption amount on the substrate for deferred redemption upon cleared validation of the coupon.

2. The coupon of claim 1 wherein the customer identifier comprises a second bar code printed on the substrate, a first bar code comprising an item bar code, the second bar code not scannable at the POS system.

3. The coupon of claim 1 wherein the customer identifier is contained within a standard coupon format printed on the substrate.

4. The coupon of claim 3 wherein a primary manufacturer identifier on the coupon employing the standard coupon format is associated with an entity managing the deferred redemption value and the secondary manufacturer identifiers on the standard coupon are associated with a manufacturer promoting a product with the coupon.

5. The coupon of claim 1 wherein the customer identifier comprises a serial number printed on the substrate.

6. The coupon of claim 1 wherein the customer identifier identifies the customer in a limited way.

7. The coupon of claim 1 wherein the first redemption amount is much less than the second redemption value, including zero.

8. The coupon of claim 1 further comprising unique indicia to draw attention to the coupon but unrelated to the customer identifier, the one or more items, and first and second redemption amounts.

9. A method of avoiding fraud in the redemption of coupons, comprising:
receiving a coupon associated with the sale of one or more items to a customer, the coupon having been redeemed for a first redemption amount by the customer;
associating a customer identifier on the coupon with the customer through a lookup table, and
providing for a second redemption amount to the customer after validation of the coupon;
whereby the possibility of fraud is reduced.

10. The method of claim 9 wherein the associating step comprises identifying the customer completely through the lookup table, the customer identifier comprising a full customer identifier.

11. The method of claim 9 wherein the associating step comprises identifying the customer partially through the lookup table, the customer identifier comprising an intermediate customer identifier.

12. The method of claim 9 where the first redemption amount is much less than the second redemption amount, or zero.

13. The method of claim 9 wherein the coupon was redeemed for the first redemption amount at a retailer POS.

14. The method of claim 9 wherein the second redemption amount providing step comprises crediting the second redemption amount to a financial account of the customer.

15. The method of claim 9 wherein the second redemption amount providing step comprises crediting points corresponding to the second redemption amount to an account of the customer.

16. The method of claim 9 wherein the second redemption amount providing step comprises mailing a check to the customer.

17. The method of claim 16 wherein the second redemption amount providing step comprises generating a check and a mailing envelope for the customer to mail the check to the customer.

18. The method of claim 9 wherein the second redemption amount providing step comprises providing for a discount corresponding to the second redemption amount in goods or services to the customer.

19. The method of claim 9 wherein the second redemption amount providing step comprises determining a total amount of deferred redemption amounts from a plurality of redeemed and validated coupons for purchases of a plurality of items by a plurality of customers; and transmitting the amount to a seller of the purchased items to pay a third party, the third party providing access to the plurality of customers.

20. The method of claim 9 further comprising:
providing the coupon to the customer associated with the customer identifier on the coupon.

21. The method of claim 20 wherein the coupon providing step comprises mailing the coupon to the customer.

22. The method of claim 21 wherein the coupon providing step comprises generating the coupon and a specially identified mail envelope for the third party to mail the coupon to the customer

23. The method of claim 20 wherein the coupon providing step comprises transmitting information through the Internet for a print-at-home coupon with the customer identifier.

24. The method of claim 20 further comprising:
receiving information of a coupon packet identifier for a coupon mailing packet in which the coupon was mailed to the customer associated with the customer identifier of one or more coupons contained in the coupon packet;
whereby the provision of the coupon to the customer can be tracked.

25. The method of claim 24 wherein the customer identifier comprises an intermediate customer identifier providing a partial identification of the customer.

26. The method of claim 25 wherein the coupon packet identifier comprises a bar-code.

27. The method of claim 20 wherein the coupon providing step comprises printing the customer identifier on a coupon mailing packet including the coupon, and providing mailing directions to a party mailing the coupon mailing packet to the customer.

28. The method of claim 27 wherein the customer identifier comprises an intermediate customer identifier providing a partial identification of the customer, the party mailing the coupon mailing packet having a mapping of the intermediate customer identifier to a full customer identifier.

29. The method of claim 20 wherein the coupon providing step comprises receiving a request from a party mailing a coupon mailing packet to the customer; transmitting coupon information for the customer to the party so that the party can print out the coupon including a customer identifier for the party to mail in the coupon mailing packet.

30. The method of claim 29 wherein the customer identifier comprises an intermediate customer identifier providing a partial identification of the customer

31. The method of claim 20 wherein the coupon providing step comprises sending a plurality of coupons divided into packet types to a party mailing a coupon mailing packet to the customer, each packet type corresponding to customer interests or tendencies; and transmitting information to the party as to which packet type of coupons to send a customer to best target that customer.

32. The method of claim 31 wherein the coupon providing step comprises receiving information from the party of a coupon packet identifier associated with a packet of coupons sent to a customer and the customer identifier of the customer so that the a coupon in the packet of coupons can be tracked to the customer.

33. The method of claim 32 wherein the customer identifier comprises an intermediate customer identifier providing a partial identification of the customer.

34. The method of claim 9 further comprising:
providing for a mechanism for the customer to select desired coupons.

35. A computer system administering the distribution and redemption of coupons, the computer system including elements comprising:
at least one processor;
at least one memory unit;
computer code stored in the memory unit; and
a network interface;
wherein the elements are configured to:
receive a coupon associated with the sale of one or more items to a customer, the coupon having been redeemed for a first redemption amount by the customer;
associate a customer identifier on the coupon with the customer through a lookup table, and
provide for a second redemption amount of the coupon amount to the customer after validation of the coupon;
whereby the possibility of fraud is reduced.

36. The computer system of claim 35 wherein the elements configured to associate a customer identifier on the coupon with the customer through a lookup table identify the customer completely through the lookup table.

37. The computer system of claim 35 wherein the elements configured to associate a customer identifier on the coupon with the customer through a lookup table identify the customer partially through the lookup table.

38. The computer system of claim 35 wherein the first redemption amount is much less than the second redemption amount, or zero.

39. The computer system of claim 35 wherein the coupon was redeemed for the first redemption amount at a retailer POS.

40. The computer system of claim 35 wherein the elements configured to provide for a second redemption amount of the coupon amount to the customer after validation of the coupon credit the second redemption amount to a financial account of the customer.

41. The method of claim 35 wherein the elements configured to provide for a second redemption amount of the coupon amount to the customer after validation of the coupon credit points corresponding to the second redemption amount to an account of the customer.

42. The computer system of claim 35 wherein the elements configured to provide for a second redemption amount to the customer after validation of the coupon generate a check and a mail envelope for a third party to mail the check to the customer.

43. The computer system of claim 35 wherein the elements configured to provide for a second redemption amount of the coupon amount to the customer after validation of the coupon provide for a discount corresponding to the second redemption amount in goods or services to the customer.

44. The computer system of claim 35 wherein the elements configured to provide for a second redemption amount of the coupon amount to the customer after validation of the coupon determine a total amount of deferred redemption amounts from a plurality of redeemed and validated coupons for purchases of a plurality of items by a plurality of customers; and transmit the amount to a seller of the purchased items to pay a third party, the third party providing access to the plurality of customers.

45. The computer system of claim 35 wherein the elements are further configured to:
provide the coupon to the customer associated with the customer identifier on the coupon.

46. The computer system of claim 45 wherein the elements configured to provide the coupon to the customer associated with the customer identifier on the coupon generate a coupon and a mail envelope for the customer to mail the coupon to the customer.

47. The computer system of claim 45 wherein the elements configured to provide the coupon to the customer associated with the customer identifier on the coupon transmit information through the Internet for a print-at-home coupon with the customer identifier.

48. The computer system of claim 45 wherein the elements are further configured to:
receive information for a coupon packet identifier for a coupon mailing packet in which the coupon was mailed to the customer associated with the customer identifier for the coupon;
whereby the provision of the coupon to the customer can be tracked.

49. The computer system of claim 48 wherein the customer identifier comprises an intermediate customer identifier providing a partial identification of the customer.

50. The computer system of claim 48 wherein the coupon packet identifier comprises a bar-code.

51. The computer system of claim 45 wherein the elements configured to provide the coupon to the customer associated with the customer identifier on the coupon print the customer identifier on a coupon mailing packet including the coupon, and provide directions to a party mailing the coupon mailing packet to the customer.

52. The computer system of claim 51 wherein the customer identifier comprises an intermediate customer identifier providing a partial identification of the customer, the party mailing the coupon mailing packet having a mapping of the intermediate customer identifier to a full customer identifier.

53. The computer system of claim 45 wherein the elements configured to provide the coupon to the customer associated with the customer identifier on the coupon receive a request from a party mailing a coupon mailing packet to the customer and transmit coupon information for the customer to the party so that the party can print out the coupon including a customer identifier to mail in the coupon mailing packet.

54. The computer system of claim 53 wherein the customer identifier comprises an intermediate customer identifier providing a partial identification of the customer

55. The computer system of claim 45 wherein the elements configured to provide the coupon to the customer associated with the customer identifier on the coupon send a plurality of coupons divided into packet types to a party mailing a coupon mailing packet to the customer, each packet type corresponding to customer interests or tendencies; and transmit information to the party as to which packet type of coupons to send a customer to best target that customer.

56. The computer system of claim 55 wherein the elements configured to provide the coupon to the customer associated with the customer identifier on the coupon receive information from the party of a coupon packet identifier associated with a packet of coupons sent to a customer and the customer identifier of the customer so that the a coupon in the packet of coupons can be tracked to the customer.

57. The computer system of claim 56 wherein the customer identifier comprises an intermediate customer identifier providing a partial identification of the customer.

58. The computer system of claim 35 wherein the elements are further configured to:
provide a mechanism for the customer to select desired coupons.
